(19) United States
(12) Patent Application Publication
(10) Pub. No.: US 2005/0019120 A1
(43) Pub. Date: Jan. 27, 2005

(54) Worm gear having thread pitch and method for making same

(75) Inventor: Paul G. Kennedy, Horseheads, NY (US)

Correspondence Address: BROWN & MICHAELS, PC;400 M & T BANK BUILDING, 118 NORTH TIOGA ST, ITHACA, NY, 14850, US

(73) Assignee: Penn Troy Manufacturing, Inc., Troy, PA (US)

(21) Appl. No.: 10/627,472

(22) Filed: Jul. 25, 2003

(51) Int. Cl. B23F 11/00; B23F 17/00

(52) U.S. Cl. 409/48; 470/1

(57) ABSTRACT

A method and system is provided for forming a gear such as a partial-turning gear using a tap. The tap acts upon a plurality of gear blanks. The method and system are free from using a hob. The gear blanks passively responds to the actions of the tap without being actuated by any other means except the tap.

### BACKGROUND OF THE INVENTION

1. Field of the Invention

The invention pertains to the field of worm gears. More particularly, the invention pertains to a worm gear having a thread pitch.

2. Description of Related Art

It is known to form a gear, wherein the outer circumference (i.e., all 360° ) of the gear is covered with a tooth-like structure. Such gears commonly are used inside a wide variety of mechanical devices, such as, for example, gear-boxes for valves, clocks, watches, compasses, motors, etc. The gear can be a worm gear, which possesses a specific pitch, with all worms associated with the gear based on that pitch (i.e., with the pitch covering the 360° circumference of the gear). Pitch is defined as the distance from center to center of any two adjacent teeth of a gear, measured on the pitch line. This type of pitch is also known as circular pitch.

All known worms and worm gears are based on a 360° formation, or have tooth-like structures distributed circumferentially upon the outside surface. For example, the formation may have 3.7836 threads per inch.

The formation of gears is different than tapping an inner thread. In fact, the formation of gears generally involves moving a gear blank for forming teeth thereon by a moving hob. The above technique is well known in the art. A list of publications detailing such technique is as follows, and the complete disclosures of each of the references on the list are hereby incorporated herein by reference in their entireties: (1) Pictorial Handbook of Technical Devices, section V, pages 404-405. (2) Encyclopedia of Modern Technology (a new companion volume thereto), Vol.2, pages 166-169. (3) Machinery's Handbook (1957), pages 774-779, 788-789, and 800-801.

One characteristic of the gearing-forming techniques of the prior art is that the gear blanks are required to move, in order for a hob to perform the tooth-forming operations. This requirement puts a demand upon the system characteristics of a gear-forming system, in that stringent system requirements are imposed. For example, the accuracy of the system needs to be such that proper tooth structures are achieved.

Taps also are known in the art of mechanical engineering. According to various characteristics, taps include, for example a straight flute tap, spiral point tap, spiral flute tap, and pipe tap. It generally is well known to use a tap for forming internal or female threads within an article, although it is not known in the art to use a tap for gear manufacturing.

Thread tapping machines are well-known in the art as well. These machines are used, for example, to tap or form female (i.e., internal) threads in articles, such as, for example, rods, fasteners, nuts and various other mechanical parts. In reference (3) of the list above, Machinery's Handbook (1957), pages 990-991 and 994-995, some types of prior art tapping are shown.

As can be seen, a thread pitch and a worm pitch are two different things from two different systems. In other words, a 360° worm pitch and 360° thread pitch are not known to properly engage or match. Therefore, a suitable device or method that can provide a thread pitch on a worm gear would achieve an improved means for forming a gear including a partial worm gear. Such improved worm gears could be widely applied in the mechanical arts, such as, for example, in gear-boxes for valves.

### SUMMARY OF THE INVENTION

A method of using a tap for forming a gear is provided. The method uses a tap, which is coupled to an actuator for supplying an actuating force on the tap. The tap, in turn, forms thread on a gear blank.

A method of using a tap for forming a partial-turn gear is provided. The method uses a tap, which is coupled to an actuator for supplying an actuating force on the tap. The tap, in turn, forms thread on a partial-turn gear blank.

A method of using a tap for forming a plurality of partial-turn gears is provided. The method uses a tap, which is coupled to an actuator for supplying an actuating force on the tap. A plurality of gear blanks passively receives the actuated tap, thereby forming threads thereon.

Accordingly, a method for forming gear threads on a gear blank is provided. The method includes: providing a tap coupled to and acted upon by an actuator; providing a plurality of blanks, wherein each blank has a surface for threading and each blank is free from actuation, other than active forces exerted by the tap; placing the blank surfaces facing each other for engagement with the tap; actuating the tap upon the blank surfaces; and forming threads on the blank surfaces.

A system for forming gears using a tap is provided. The system includes: a tap driver; a tap coupled to and driven by the tap driver; and a plurality of gear blanks, wherein each blank has a surface disposed to be engagable by the tap for threading thereon; whereby gears are formed free from a hob and active actuation on the gear blanks.

### BRIEF DESCRIPTION OF THE DRAWING

FIG. 1 shows an embodiment of the present invention.

FIG. 2 shows a flowchart depicting an embodiment of the method of the present invention.

FIG. 3 shows a first example of a blank of the present invention.

FIG. 4 shows a second example of a blank of the present invention.

FIG. 5 shows a third example of a blank of the present invention.

### DETAILED DESCRIPTION OF THE INVENTION

The present invention involves the formation of less than 360° turn gears, such as for use in quarter-turn gear boxes. The less than 360° segment gear may be used for meshing with a worm, wherein the worm has a threaded pitch, formed by means of using a tap.

As can be appreciated, a gear having its circumference (all 360° ) covered with tooth-like structures is known. In some cases, a less than 360° turn gear is required or desired. In these cases, it may not be necessary to actively actuate the gear blanks under processing. That is to say, to put threads on a partial-turn gear, such as a quarter-turn worm gear, no actuator for the blanks is needed. In other words, a partial-turn gear blank passively receives the action of a tap, which is coupled to an actuator, while the blanks themselves do not receive actuating actions, other than from the tap.

Partial-turn gears have extensive use in industry. By way of an example, there is a big market for x° turn gears (i.e., wherein “x” is equal to a number less than 360), which may be used in association with such devices as valves, for example. One of the characteristics of the x° turn gears is that a less than 3600 turn is required. Generally, quarter-turn gears are x° turn gears that require about a 90° turn. Because of this characteristic, a tap, which is known to be used for threading such members as an article with a hollow blank element, can be used to prepare the x° turn gears. Preferably, more than one x° turn gear is used for this process.

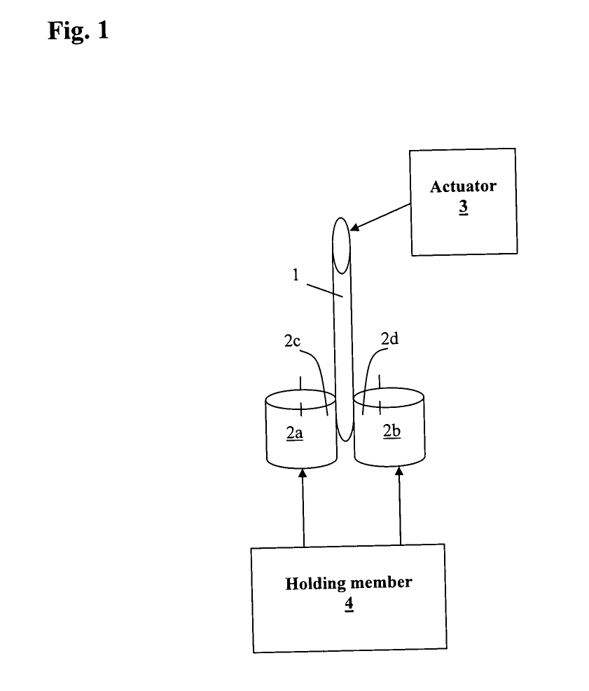

FIG. 1 shows a system and method for forming a pair of less than 360° turn gears. A tap 1, which is normally used for threading female or internal threads, is provided. Tap 1 engages a plurality of partial-turn gear blanks. Only two partial-turn gear blanks are shown, i.e., blank 2a and blank 2b. Each partial-turn blank has a partial-turn surface 2c and 2d, respectively. Only the partial-turn surfaces 2c and 2d are engaged by tap 1. It is noted that in FIG. 1, each of the partial-turn blanks possesses a partial-turn surface, which protrudes outward in relation to the rest of the blank structure for suitable engagement with tap 1.

Tap 1 having protrusions (not shown) thereon is actuated by an actuator 3, which may give tap 1 a turning force. It is noted that the actuating mechanism 3 and tap 1 may be similar to prior art devices for forming female threading. However, the present invention teaches using a tap for forming a gear, such as, for example, a quarter-turn worm gear. Further, the whole structure of the partial-turn blank may reside within a holding member 4. Holding member 4 facilitate a desired turning action, caused by the actuating force of the tap. Thereby, the partial-turn blank surface can be evenly threaded. There is no actuating force exerted by holding member 4 upon any partial-turn blank.

As can be appreciated, the present invention forgoes the elaborate process of gear forming using a hob acting upon gear blanks, which requires an actuator acting thereon. Because the present invention teaches forming partial-turn gears, the force exerted by the tap is sufficient for threading on the blank surfaces, which does not have the 360 degree characteristics. Therefore, the blanks can be positioned passively to receive the tap. A holding member may be required to facilitate a smooth turning of the blanks.

It should be noted that the present invention also contemplates the manufacture of full 360 degree turning gears using a tap. However, the preferred embodiment is a method for forming partial-turn worm gears.

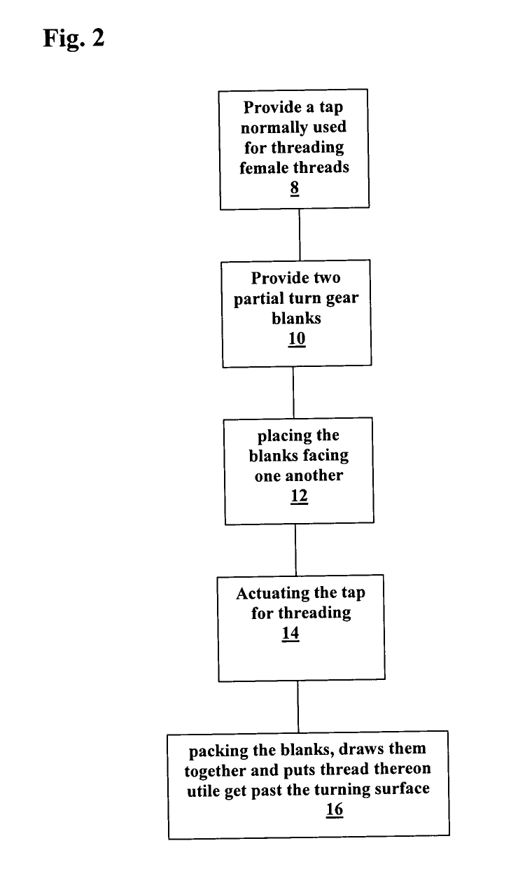

The present invention teaches cutting a gear with a thread pitch using a thread rod or tap. The thread rod or tap are preferably of the widely available and the inexpensive type. The present invention teaches cutting teeth on a gear in a novel and special way, using the threading mechanism of a tap, which is generally used for internal threading purposes. FIG. 2 shows a method for performing the cutting process.

Referring to FIG. 2, a tap, which normally is used for threading female threads within an article, is provided (step 8). The tap preferably is coupled to and actuated upon by an actuator, which may include a motor. Further, the tap may be any commonly available piece in a shop for thread forming. A set of gear blanks are provided (step 10). The gear blanks may possess a partial-turning surface, such as a x° turning surface. The gear blanks are placed or allocated to face each other for the tap to suitably engage the same (step 12). The tap is than actuated (step 14). The actuation may be done by means of coupling the tap to an actuator, as shown in FIG. 1. The blanks, which are packed in a holding member (not shown), passively receive the tap. The tap in turn draws the blanks together and forms thread on the turning surfaces of the blanks (16). As can be seen in FIG. 1, the turning surfaces of the blanks are on the outside circumference of the gear blanks. This is different from what a tap is generally known to be used for. In other words, the tap is not used in the typical manner, upon an inner surface, such as a surface of the known female or internal thread.

As a special example, the following are more specific steps in relation to the method or flowchart of FIG. 2.
taking two x° turn gear blanks;
placing the same facing one another;
taping threads on the turning surfaces thereon;
packing the two x° turn gear blanks; and
drawing the two x° turn gear blanks together and putting thread in until the blanks turn past 90 degrees, whereby no turning surface is engagable by the tap.

The present invention teaches a method using a tap instead of using a hob for forming gear teeth. The method forgoes the usage of extensive and expensive machinery, including means for actively moving the gear blanks for tooth cutting by a hob. The method simply uses a tap, as shown in the above process. Thereby it is less expensive in making gears having less than 360 degree turns. The resultant gear may be used for interacting with worms.

In addition, referring again to FIGS. 1 and 2, as shown there are only two blanks in FIG. 1. However, the present invention contemplates any even number of blanks suitably arranged around a tap such as tap 1 of FIG. 1 so long as the tap can engage the surfaces for forming desired threads thereon. Furthermore, the present invention contemplates any number of gear blanks which are adapted to form a circle having a tap disposed in the center for engaging each blank. Each blank needs to have a surface respectively being engagable by the tap.

It is again noted that generally thread pitch is distinct from gear pitch. However, the present invention teaches a method for forming gear pitch using a tap which is generally only known to be used for thread pitch forming.

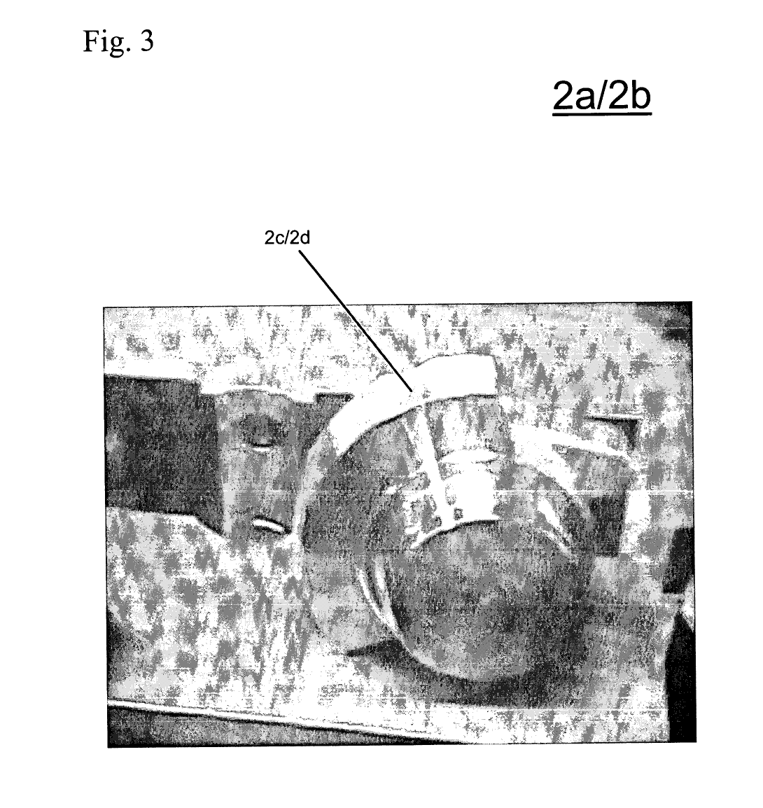

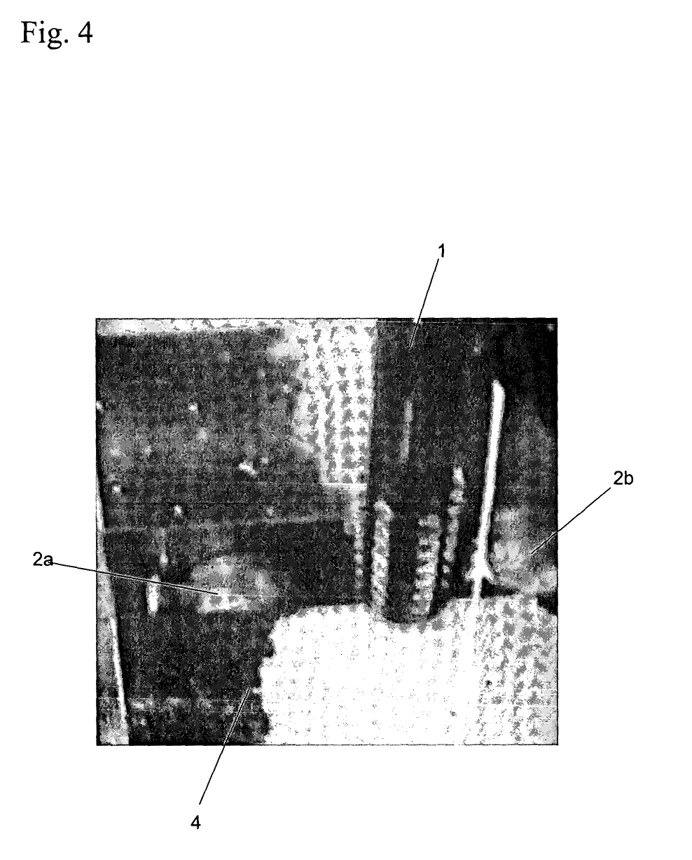

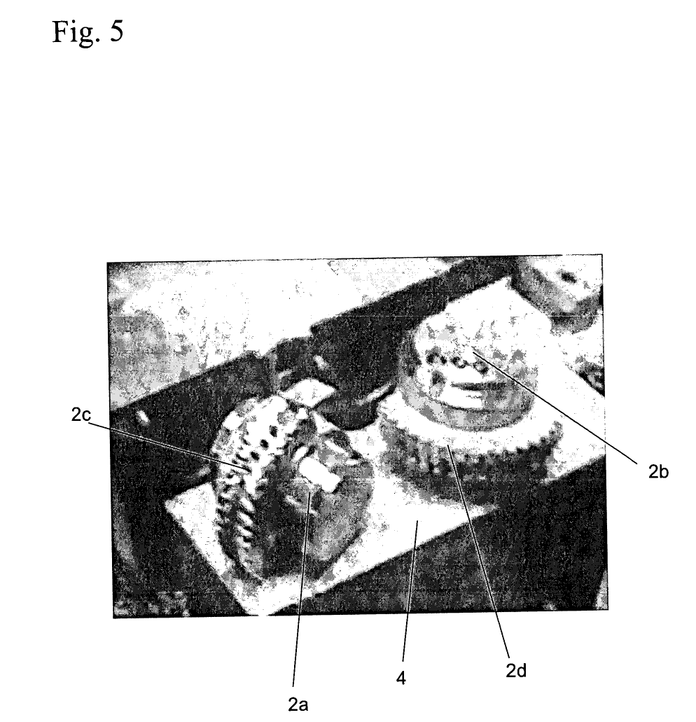

The following figures, FIGS. 3-5, show a real life example of the present invention. Referring to FIG. 3, a blank 2a or 2b of the present invention is provided. Note the partial turning surface 2c or 2d before thread is formed thereon. Referring to FIG. 4, an exemplified picture of FIG. 1 is depicted. Note the tap 1 engaging or threading upon two blanks (2a and 2b), and holding member 4 holding the two blanks therein. Referring to FIG. 5, the finished product having the partial turning surfaces 2c, 2b fully formed sitting upon the holding member is depicted. Noted the fully formed member derived from blank 2a and blank 2b.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

1. A method for forming gear pitches on a gear blank, comprising:
providing a tap coupled to and acted upon by an actuator;
providing a plurality of blanks, wherein each blank has a surface for threading and each blank is free from actuation, other than forces exerted by the tap;
placing the blank surfaces facing each other for engagement with the tap;
actuating the tap upon the blank surfaces; and
forming threads on the blank surfaces.

2. The method of claim 1 further comprising providing a holding member for passively holding the blanks.

3. The method of claim 1 further comprising providing coolant to the blanks.

4. The method of claim 1, wherein the blank surface is a partial-turn surface.

5. The method of claim 4, wherein the partial-turn surface is a quarter-turn surface.

6. The method of claim 1, wherein the set of blanks includes blanks being less thank 360 degree turn blanks.

7. The method of claim 1, wherein the set of blanks includes blanks being quarter-turn or 90 degree turn blanks.

8. The method of claim 1, wherein the set of blanks comprises a set of two blanks.

9. A system for forming gears using a tap comprising:
a tap driver;
a tap coupled to and driven by the tap driver; and
a plurality of gear blanks, wherein each blank has a surface disposed to be engagable by the tap for threading thereon; whereby gears are formed free from a hob and actuation on the gear blanks.

10. The system of claim 10 further comprising a holding member wherein the set of blanks is being held for engaging with the tap.
